(19) United States
(12) Patent Application Publication
(10) Pub. No.: US 2015/0015954 A1
(43) Pub. Date: Jan. 15, 2015

(54) CAMERA MODULE

(71) Applicant: SAMSUNG ELECTRO-MECHANICS CO., LTD., Suwon-Si (KR)

(72) Inventors: Jae Ho Baik, Suwon-Si (KR); Jung Seok Lee, Suwon-si (KR); Myung Ki Lee, Suwon-Si (KR); Jae Hyuk Lee, Suwon-si (KR); Po Chul Kim, Suwon-si (KR); Woon Ki Kim, Suwon-si (KR); Chuel Jin Park, Suwon-si (KR)

(73) Assignee: SAMSUNG ELECTRO-MECHANICS CO., LTD., Suwon-Si (KR)

(21) Appl. No.: 14/326,464

(22) Filed: Jul. 9, 2014

(30) Foreign Application Priority Data
Jul. 9, 2013 (KR) 10-2013-0080290
Jul. 3, 2014 (KR) 10-2014-0083108

(51) Int. Cl. G02B 27/00; G02B 7/02

(52) U.S. Cl. CPC G02B 27/0006; G02B 7/02
USPC 359/507; 359/819

(57) ABSTRACT

There is provided a camera module including: a lens barrel having a lens; and a housing having the lens barrel inserted thereinto, wherein an outer surface of the lens barrel facing an inner surface of the housing is provided with a first groove formed inwardly concave, and the inner surface of the housing is provided with a first foreign object collecting portion formed with a step difference and a second foreign object collecting portion formed with a step difference from the first foreign object collecting portion.

### CROSS-REFERENCE TO RELATED APPLICATIONS

This application claims the benefit of Korean Patent Application No. 10-2013-0080290 filed on Jul. 9, 2013, and 10-2014-0083108 filed on Jul. 3, 2014, with the Korean Intellectual Property Office, the disclosures of which are incorporated herein by reference.

### BACKGROUND

The present disclosure relates to a camera module.

In general, it is common for mobile communications terminals such as mobile phones, PDAs, and PCs to not only transmit text messages or voice data but also image data.

Following this trend, recent mobile communication terminals are standardly equipped with camera modules to capture image data or to perform video chatting.

Typically, a camera module includes a lens barrel having lenses therein, a housing accommodating the lens barrel therein, and an image sensor converting an image of a subject into an electrical signal.

Traditionally, a short-focus type camera module imaging objects with a fixed focus has been employed. Recently, as a technology has evolved, however, camera modules including an actuator that enables auto-focusing have been employed.

With this auto-focus function, a distance between the lens barrel having lenses therein and the image sensor is adjusted, such that the subject may be clearly imaged on the image sensor.

Accordingly, in order to implement the auto-focus function; the lens barrel should be movable along the optical axis, and a predetermined space is formed between the lens barrel and the housing so as to avoid friction therebetween.

However, if foreign objects are introduced into the space to reach the image sensor, image deterioration, flaring, and the like, may occur so that the camera module may be adversely influenced.

### SUMMARY

An aspect of the present disclosure may provide a camera module capable of preventing, even if foreign objects have been introduced into the camera module, the introduced foreign objects from reaching an image sensor.

According to an aspect of the present disclosure, a camera module may include: a lens barrel having one or more lenses positioned along an optical axis; and a housing having the lens barrel therein, wherein the housing includes a first through hole into which the lens barrel is inserted and a second through hole having a diameter larger than that of the first through hole.

The first through hole and the second through hole may be connected to each other by a stepped portion, wherein a first collecting groove may be formed in the stepped portion.

The housing may have a fixing groove in a lower inner surface thereof, wherein the fixing groove may have an infrared filter attached thereto.

A window may be formed between the lens barrel and the infrared filter through which light from the lens passes, wherein the window may have a circular plane.

The lens barrel may have, on an outer surface thereof, a protruding portion facing an inner surface of the housing in which the second through hole is formed.

The protruding portion may have a second collecting groove formed in an upper surface thereof.

A diameter of the lens barrel in a position in which the protruding portion is formed may be greater than that of the first through hole and smaller than that of the second though hole.

According to another aspect of the present disclosure, a camera module may include: a lens barrel having one or more lenses positioned along an optical axis; and a housing having the lens barrel therein, wherein at least two step structures are formed between an inner surface of the housing and an outer surface of the lens barrel.

The inner surface of the housing may be stepped, wherein the stepped portion may have a first collecting groove formed therein.

A protruding portion may be formed on the outer surface of the lens barrel so as to correspond to the step structure on the inner surface of the housing.

The protruding portion may have a second collecting groove formed in an upper surface thereof.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment of the present disclosure;

FIG. 2 is a cross-sectional view of the camera module according to an exemplary embodiment of the present disclosure;

FIG. 3 is a perspective view of a housing of the camera module according to an exemplary embodiment of the present disclosure;

FIG. 4 is a cross-sectional view of the camera module according to an embodiment of the present disclosure in which a housing and an infrared filter are coupled to each other;

FIG. 5 is a perspective view of the housing and the infrared filter according to an exemplary embodiment of the present disclosure, seen from below;

FIG. 6 is a perspective view of a lens barrel of the camera module according to an exemplary embodiment of the present disclosure;

FIG. 7 is a cross-sectional view of a lens barrel of the camera module according to an exemplary embodiment of the present disclosure;

FIG. 8 is an exploded perspective view of a camera module according to another exemplary embodiment of the present disclosure;

FIG. 9 is a cross-sectional view illustrating an assembled state of the camera module according to another exemplary embodiment of the present disclosure;

FIG. 10A is a perspective view of the lens barrel provided in the camera module according to another exemplary embodiment of the present disclosure;

FIG. 10B is a side view of the lens barrel provided in the camera module according to another exemplary embodiment of the present disclosure;

FIG. 11A is a perspective view of a first modified example of the lens barrel shown in FIG. 10A;

FIG. 11B is a side view of the lens barrel illustrated in FIG. 11A;

FIG. 12 is a side view of a second modified example of the lens barrel illustrated in FIG. 10A;

FIG. 13 is a side view of a third modified example of the lens barrel illustrated in FIG. 10A; and

FIG. 14 is a side view of a fourth modified example of the lens barrel illustrated in FIG. 10A.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

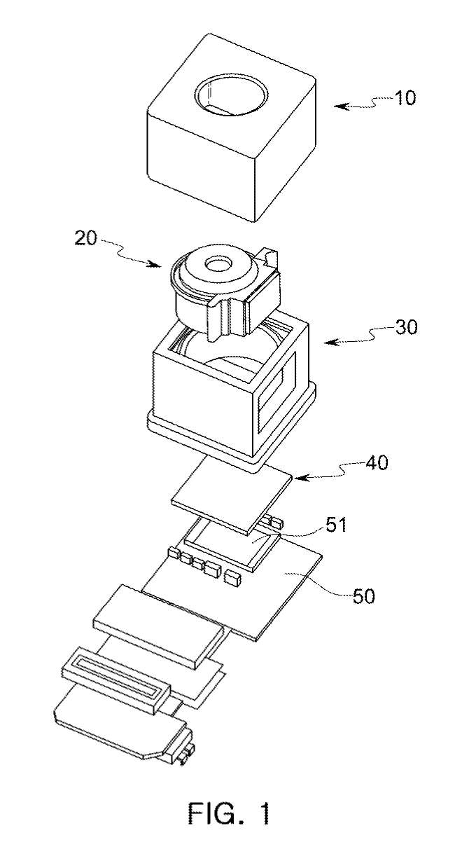

FIG. 1 is an exploded perspective view of a camera module according to an exemplary embodiment of the present disclosure.

Referring to FIG. 1, the camera module according to an exemplary embodiment of the present disclosure may include a lens barrel 20, a housing 30, a case 10, an infrared (IR) filter 40, an image sensor 51, and a printed circuit board 50.

First, with respect to the lens barrel 20, an optical axis direction refers to a vertical direction, while a direction perpendicular to the optical axis direction refers to a horizontal direction.

The lens barrel 20 may have a hollow cylindrical shape so that one or more lenses for imaging a subject may be accommodated therein. The lenses may be placed in the lens barrel 20 in the optical axis direction.

The lens barrel 20 may be coupled to the housing 30, and more specifically, may be placed inside the housing 30.

Here, the lens barrel 20 may be moved in the optical axis direction for auto-focusing.

In order to move the lens barrel 20 in the optical axis direction, an actuator (not shown) including a voice coil motor may be provided in the housing 30.

The actuator (not shown) may include a coil, a magnet, and a yoke. The coil may move the lens barrel 20 in the optical axis direction through attractive and repulsive force with the adjacent magnet.

The magnet generates a constant magnetic field. When the coil is powered, a driving force is generated by the electromagnetic force between the magnet and the coil, such that the lens barrel 20 may be moved in the optical axis direction by the driving force.

The unit for moving lens barrel 20 is not limited to an actuator 30 including a voice coil motor (VCM), but may be various types of unit such as a mechanical driving type unit or a piezoelectric type unit using a piezoelectric device.

An auto-focusing function or a zoom function may be performed by moving the lens barrel 20 as described above.

Meanwhile, the coil may have a position sensor at a center.

The position sensor may sense the current position of the lens barrel 20 to provide it to a control unit (not shown). The control unit (not shown) may use the information on the current position of the lens barrel 20 provided by the position sensor and information on a position to which the lens barrel 20 is to be moved, so as to control the moving of the lens barrel 20.

Since the position sensor is located at the center of the coil, a separate space for locating the position sensor in the housing 30 may not be necessary, such that the actuator (not shown) may be reduced in size and manufacturing tolerances during the manufacturing process may be decreased.

The case 10 may be coupled to the housing 30 so that it covers the outer surfaces of the housing 30. The case 10 may block an electromagnetic wave generated during the driving of the camera module.

That is, electromagnetic fields generated while the camera module is driven, and if the electromagnetic fields as described above are emitted to the outside, other electronic components may be influenced so that communication disruptions or malfunctions may be caused by the electromagnetic fields.

Therefore, the case 10 may be coupled to the housing 30 in order to block the electromagnetic field from being emitted to the outside.

Here, the case 10 may be grounded to a ground pad (not shown) provided on the printed circuit board 50, such that the electromagnetic fields may be blocked.

The case 10 may have a through hole at a top surface thereof, so that light from the outside may come through the lens barrel 20, and the light coming through the through hole may be received by the image sensor 51 through the lenses.

The image sensor 51 such as a charge coupled device (CCD) or a complementary metal oxide semiconductor (CMOS) may be mounted on the printed circuit board 50 through wire bonding, and the printed circuit board 50 may be coupled to the bottom of the housing 30.

An image of a subject may be collected on the image sensor 51 to be stored as data in the memory in a device, and the stored data may be displayed as video by a display medium in the device.

Here, an infrared (IR) filter 40 may be disposed between the lens barrel 20 and the image sensor 51.

That is, the infrared filter 40 may be disposed below the lens barrel 20.

The infrared light within the light having passed through the lenses may be blocked as the light passes through the infrared filter 40, thereby preventing the infrared light from being introduced into the image sensor 51.

The infrared filter 40 may be formed of a glass material, and may be manufactured by depositing various materials having different refractive indices in surfaces thereof in order to block light in the infrared region.

The infrared filter 40 may be bonded to an inner surface of the housing 30. That is, the infrared filter 40 may be bonded to the housing 30 by means of a UV curable adhesive (not shown).

Specifically, the housing 30 may have a fixing groove protruded outwardly in the horizontal direction on an inner surface thereof, and the infrared filter 40 may be bond to the fixing groove 37.

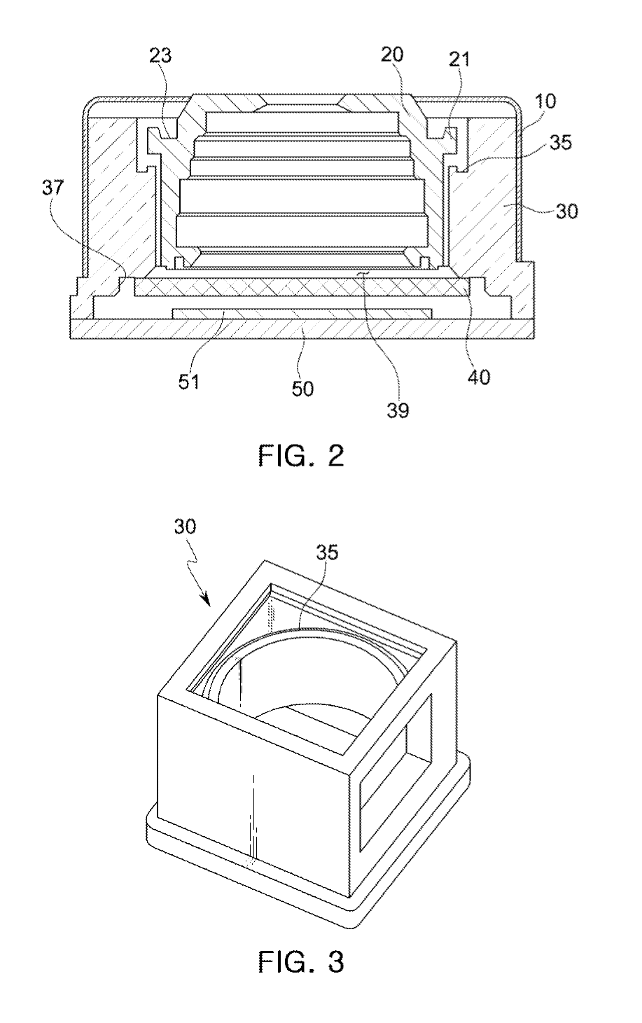

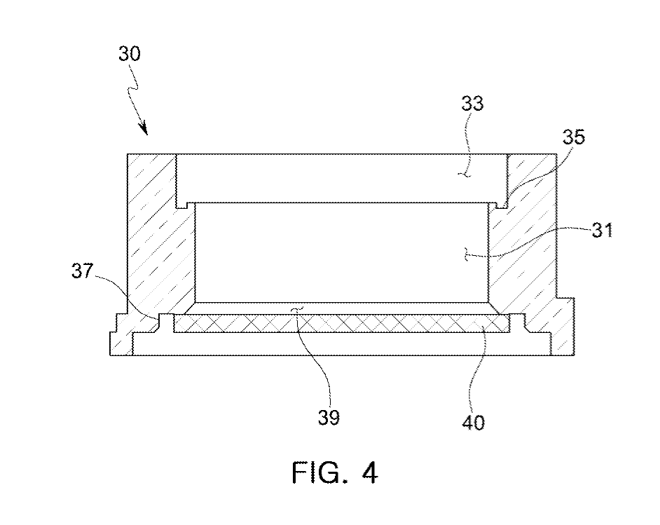

FIG. 2 is a cross-sectional view of a camera module according to an exemplary embodiment of the present disclosure, and FIG. 3 is a perspective view of a housing of a camera module according to an exemplary embodiment of the present disclosure.

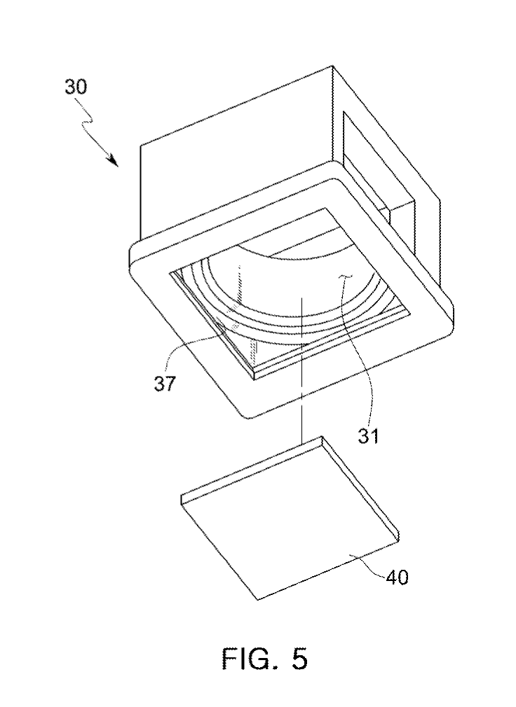

Further, FIG. 4 is cross-sectional view of a camera module according to an embodiment in which a housing and an infrared filter are coupled to each other, and FIG. 5 is a perspective view of the housing and the infrared filter according to the embodiment, seen from below.

Referring to FIGS. 2 through 5, the housing 30 included in the camera module according to an exemplary embodiment of the present disclosure may have the infrared filter 40 attached thereto.

The infrared filter 40 may be disposed at the lower part of the housing 30, between the lens barrel 20 and the image sensor 51.

The housing 30 may have a fixing groove 37 formed therein for fixing the infrared filter 40. That is, the fixing groove 37 may be formed in a lower inner surface of the housing 30 to form a step structure with the inner surface on which the fixing groove 37 is not formed, such that the infrared filter 40 may be attached to the fixing groove 37.

If an inwardly protruding structure is formed on the lower inner surface of the housing 30 for attaching the infrared filter 40, the size of the camera module is increased by the size of the protruding structure.

In contrast, in the camera module according to an exemplary embodiment of the present disclosure, instead of forming a separate structure in the housing 30 for attaching the infrared filter 40 to the housing 30, the fixing groove 37 is formed in the lower inner surface of the housing 30.

Accordingly, in the camera module according to an exemplary embodiment of the present disclosure, a separate structure for attaching the infrared filter 40 is not necessary, such that the camera module can be smaller and thinner.

Incidentally, the housing 30 may have openings in the top and bottom thereof, and may have a window 39 therein through which the light from the lenses passes. That is, the space between the lens barrel 20 and the infrared filter 40 may serve as the window 39, and the window 39 may have a circular plane.

As described above, instead of forming a separate structure protruding in the housing 30 for attaching the infrared 20 filter 40 to the housing 30, the fixing groove 37 is formed in the lower inner surface of the housing 30, such that the window 39 may have a circular plane and thus the camera module can be smaller and thinner.

Now, the inner structure of the housing 30 will be described with reference to FIGS. 3 and 4.

The housing 30 may have the lens barrel 20 inserted thereinto. That is, the housing 30 may have a hollow therein, and an upper inner diameter thereof may be greater than a lower inner diameter thereof.

Specifically, the housing 30 may have a first through hole 31 in which the lens barrel 20 is inserted, and a second through hole 33 having a greater diameter than that of the first through hole 31.

The first and second through holes 31 and 33 may be connected to each other with a step difference. That is, the inner surface of the housing 30 may be stepped.

Further, a first collecting groove 35 may be formed in the stepped portion and extended along the inner surface of the housing.

Further, although not shown in the drawings, an adhesive material may be applied on the inner surface of the housing 30.

If foreign objects are introduced into a camera module to enter an image sensor, it may cause adverse influences such as image deterioration or flaring.

However, in the camera module according to an exemplary embodiment of the present disclosure, by forming the upper inner diameter of the housing 30 greater than the lower inner diameter of the housing 30 so as to form a step structure, even if foreign objects have been introduced into the camera module according to an exemplary embodiment of the present disclosure, foreign objects may be collected by the step structure.

Moreover, by forming the first collecting groove 35 on the stepped portion, foreign objects may be collected in the first collecting groove 35, thereby preventing foreign objects from being introduced into the image sensor 51.

Further, even if foreign objects are introduced into the camera module, they stick to the adhesive material applied on the inner surface of the housing 30, thereby preventing foreign objects from reaching the image sensor.

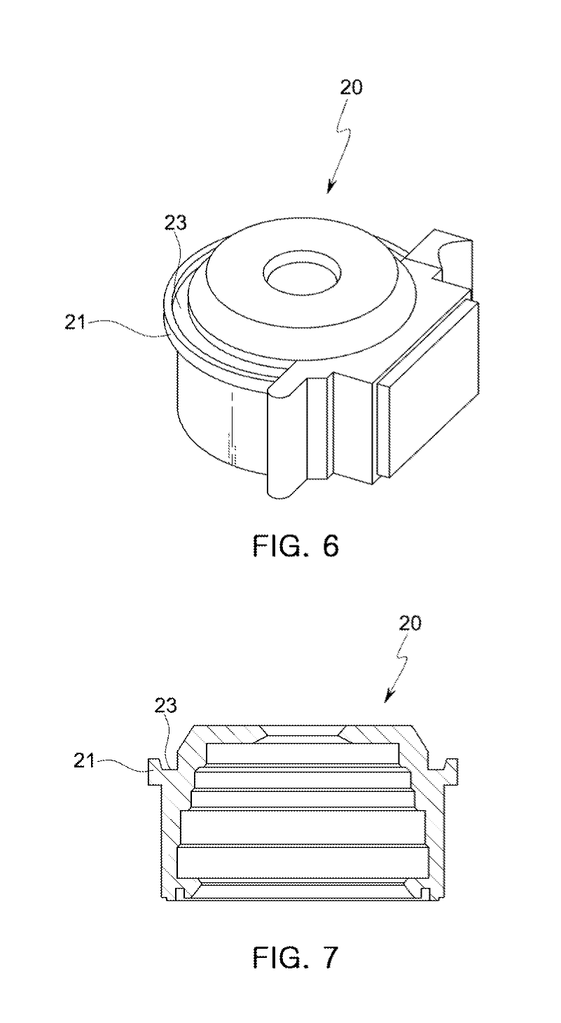

FIG. 6 is a perspective view of a lens barrel of a camera module according to an exemplary embodiment of the present disclosure, and FIG. 7 is a cross-sectional view of the lens barrel of the camera module according to an exemplary embodiment of the present disclosure.

The structure of the lens barrel 20 provided in the camera module according to an exemplary embodiment of the present disclosure will hereinafter be described with reference to FIGS. 6 and 7.

The lens barrel 20 may have a hollow cylindrical shape so that one or more lenses for imaging a subject may be accommodated therein. The lenses may be placed in the lens barrel 20 in the optical axis direction.

The lens barrel 20 may be provided in the housing 30.

The housing 30 may have first and second through holes 31 and 33 so that the lens barrel 20 is inserted thereinto. The second through hole 33 has a diameter greater than that of the first through hole 31. The first and second through holes 31 and 33 may be connected to each other with a step difference.

That is, the inner surface of the housing 30 may be stepped, and a protruding portion 21 may be formed on the outer surface of the lens barrel 20 so as to correspond to the stepped portion on the inner surface of the housing 30.

The protruding portion 21 may face the inner surface of the housing 30.

Specifically, the protruding portion 21 may face a portion of the inner surface of the housing 30, in which the second through 15 hole 33 is formed.

Accordingly, the diameter of the lens barrel 20 where the protruding portion 21 is formed may be greater than that of the first through hole 31 and smaller than that of the second through hole 33.

Since the protruding portion 21 protrudes from the outer surface of the lens barrel 20, the outer surface of the lens barrel 20 where the protruding portion 21 is formed may have a step difference.

That is, at least two step structure may be formed between the inner surface of the housing 30 and the outer surface of the lens barrel 20.

In addition, a second collecting groove 23 may be formed on the upper surface of the protruding portion 21, which is impressed downwardly in the optical axis direction. The second collecting groove 23 may extend along the upper surface of the protruding portion 21.

Further, although not shown in the drawings, an adhesive material may be applied on outer surface of the lens barrel 20.

In the camera module according to an exemplary embodiment of the present disclosure, by forming the protruding portion 21 protruding from the outer surface of the lens barrel 20 so as to form the outer surface of the lens barrel 20 with a step difference, even if foreign objects have been introduced into the camera module according to the embodiment, foreign objects may be collected by the step structure.

Moreover, by forming the second collecting groove 23 on the protruding portion 21, foreign objects are collected in the second collecting groove 23, thereby preventing foreign objects from being introduced into the image sensor 51.

Further, even if foreign objects are introduced into the camera module, they stick to the adhesive material applied on the inner surface of the housing 30, thereby preventing foreign objects from reaching the image sensor.

In conclusion, in the camera module according to an exemplary embodiment of the present disclosure, by forming at least two step structures between the inner surface of the housing 30 and the outer surface of the lens barrel 20, even if foreign objects are introduced into the camera module, they are prevented from reaching the image sensor 51.

Each of the step structures may have the first and second collecting grooves 35 and 23, respectively, to collect foreign objects. Further, by applying an adhesive material onto at least one of the inner surface of the housing 30 and the outer surface of the lens barrel 20, it may be possible to effectively prevent foreign objects from being introduced into the image sensor.

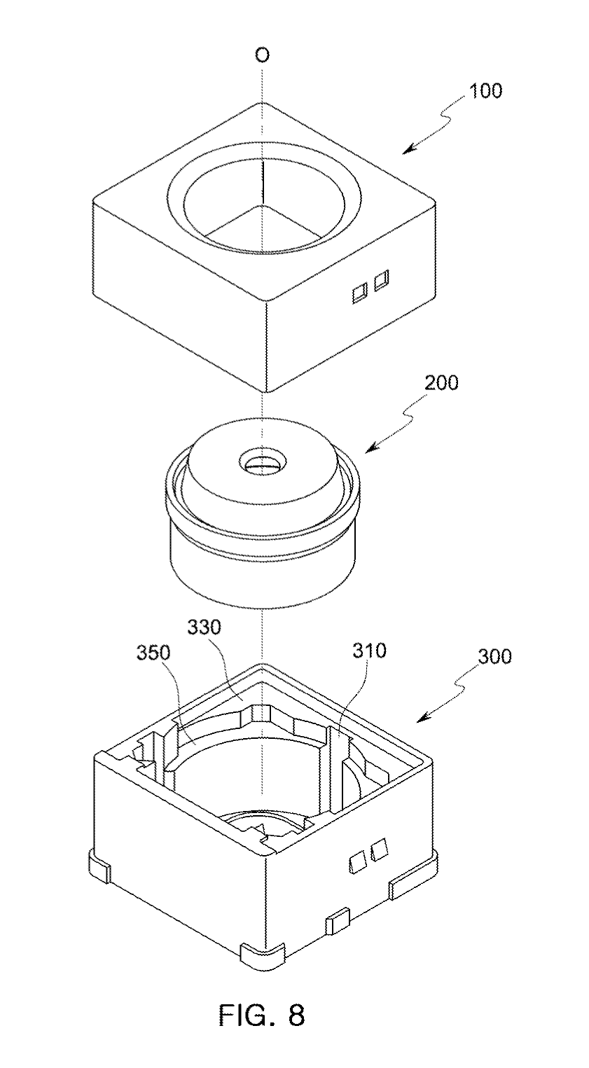

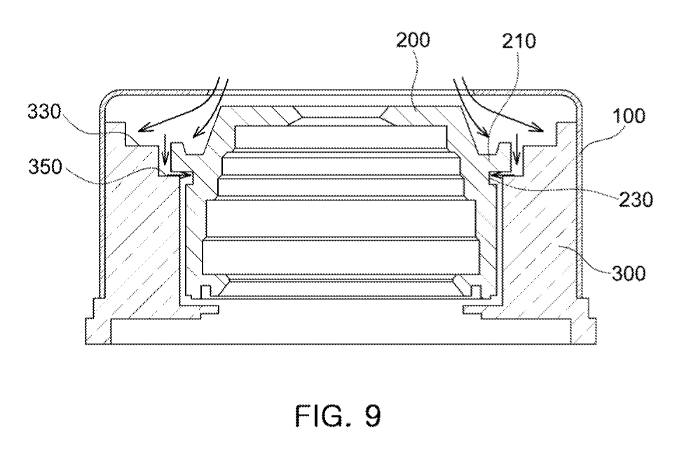

FIG. 8 is an exploded perspective view of a camera module according to another exemplary embodiment of the present disclosure; while FIG. 9 is a cross-sectional view illustrating an assembled state of the camera module according to another exemplary embodiment of the present disclosure.

Referring to FIGS. 8 and 9, the camera module according to another exemplary embodiment of the present disclosure may include a case 100, a lens barrel 200, and a housing 300.

The lens barrel 200 may have a hollow cylindrical shape so that a plurality of lenses for imaging a subject may be accommodated therein. The plurality of lenses may be placed in the lens barrel 200 in an optical axis direction.

The lens barrel 200 may be coupled to the housing 300. For example, the lens barrel 200 may be inserted into the housing 300, and the lens barrel 200 may be driven within the housing 300 in the optical axis (O) direction for auto-focusing.

In the case in which the lens barrel 200 has a hollow cylindrical shape, the housing 300 may include a hollow portion stepped in the optical axis (O) direction so that the lens barrel 200 may be inserted thereinto, and an outer surface of the lens barrel 200 and an inner surface of the housing 300 may face each other in a horizontal direction (a direction perpendicular to the optical axis (O) direction).

In this case, a portion of the inner surface of the housing 300 facing the outer surface of the lens barrel 200 may be formed as a flat plane 310, and the flat plane 310 may serve as a reference plane so as to prevent an optical axis of the lens barrel 200 from being misaligned at the time of inserting the lens barrel 200 into the housing 300.

Referring to FIG. 9, a predetermined gap may be formed between the lens barrel 200 and the housing 300. In the case in which foreign objects are introduced into the camera module, these foreign objects may be introduced into an image sensor through the gap to thereby negatively influence resolution.

Therefore, in the camera module according to another exemplary embodiment of the present disclosure, a first foreign object collecting portion 330 may be formed in the inner surface of the housing 200 with a step difference, and a second foreign object collecting portion 350 may be formed with a step difference from the first foreign object collecting portion 330.

That is, two step structures are provided in the inner surface of the housing 300 by the first and second foreign object collecting portions 330 and 350.

When foreign objects move along the inner surface of the housing 300 in the optical axis (O) direction, movement of the foreign objects in the optical axis (O) direction may be limited by the step structures.

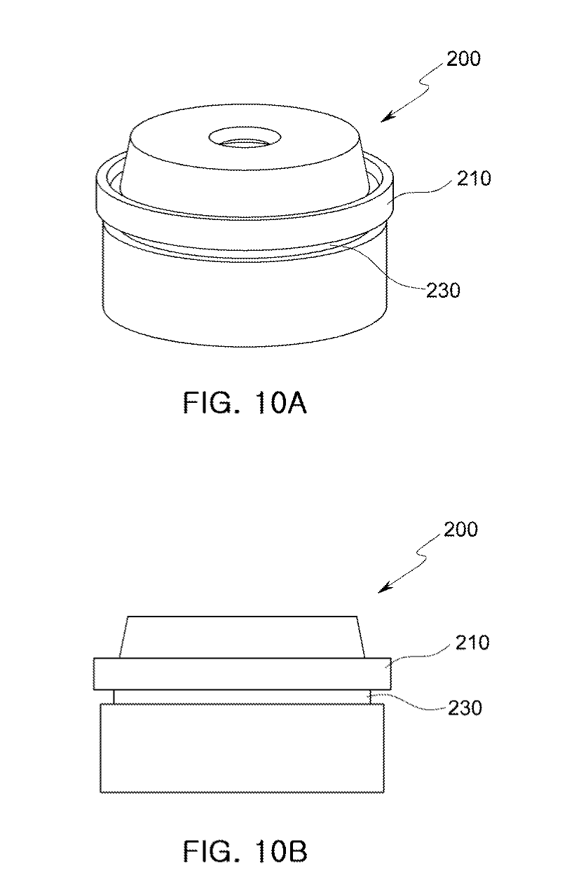

FIG. 10A is a perspective view of the lens barrel provided in the camera module according to another exemplary embodiment of the present disclosure, and FIG. 10B is a side view of the lens barrel provided in the camera module according to another exemplary embodiment of the present disclosure.

Referring to FIGS. 10A and 10B, the outer surface of the lens barrel 200 facing the inner surface of the housing 300 may be provided with a protruding portion 210 protruding in a position corresponding to the second foreign object collecting portion 350, and the outer surface of the lens barrel 200 positioned upwardly of the protruding portion 210 in the optical axis (O) direction may be inclined.

Accordingly, foreign objects move along the inclined surface to thereby be collected on an upper surface of the protruding portion 210.

A collecting groove may be formed in the upper surface of the protruding portion 210 in order to significantly increase an effect of collecting foreign objects.

In addition, a first groove 230 formed from the outer surface of the lens barrel 200 to be inwardly concave may be provided below the protruding portion 210 in the optical axis (O) direction.

The gap between the lens barrel 200 and the housing 300 may be expanded by the first groove 230, and foreign objects moving through the gap may be collected in the first groove 230, thereby preventing foreign objects from being introduced into the image sensor.

Here, a process of collecting foreign objects will be briefly described with reference to FIG. 9.

Foreign objects introduced into the camera module may be collected in the first foreign object collecting portion 330 provided in the housing 300 or/and in the upper surface of the protruding portion 210 provided in the lens barrel 200.

Remaining foreign objects, not collected, may be collected in the second foreign object collecting portion 350 provided in the housing 300 while moving through the gap between the lens barrel 200 and the housing 300. Remaining foreign objects, not collected in this portion, may be collected in the first groove 230 provided in the lens barrel 200.

As described above, in the camera module according to another exemplary embodiment of the present disclosure, the introduction of foreign objects into the image sensor may be prevented by repeatedly collecting foreign objects in portions in which a movement direction of foreign objects is changed, while changing the movement direction of foreign objects.

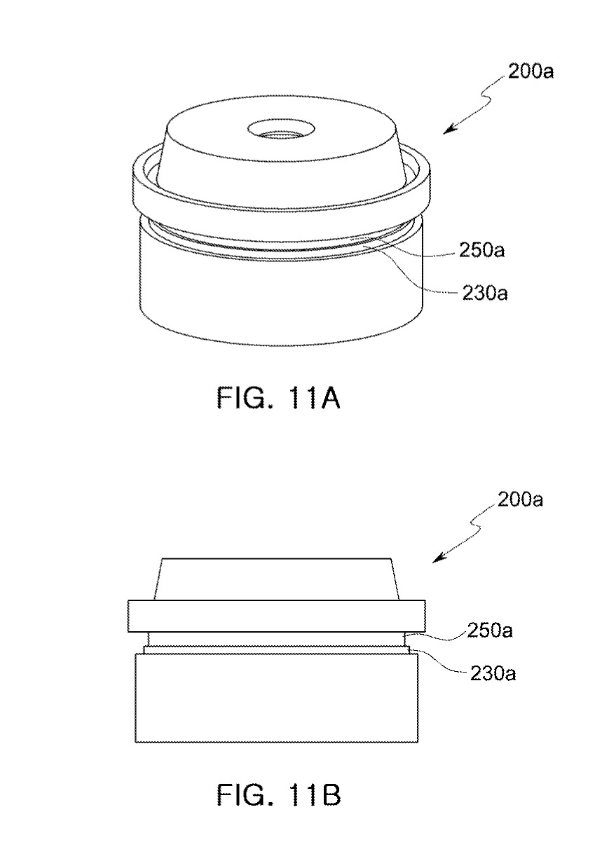

FIG. 11A is a perspective view of a first modified example of the lens barrel shown in FIG. 10A, and FIG. 11B is a side view of the lens barrel shown in FIG. 11A.

An outer surface of a lens barrel 200a may be further provided with a second groove 250a formed from a first groove 230a so as to be inwardly concave.

Therefore, since a step structure may be formed in the first groove 230a, movement of foreign objects in the optical axis (O) direction may be further limited. In addition, since a gap between the lens barrel 200a and the housing 300 may be further expanded, an amount of foreign objects collected may be increased, thereby preventing foreign objects from being introduced into the image sensor.

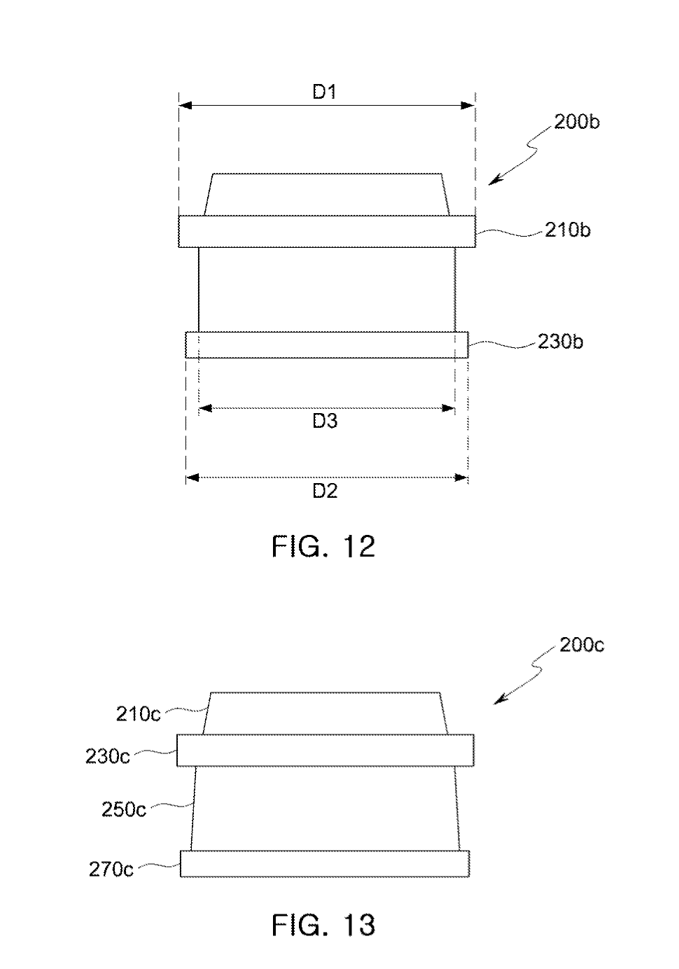

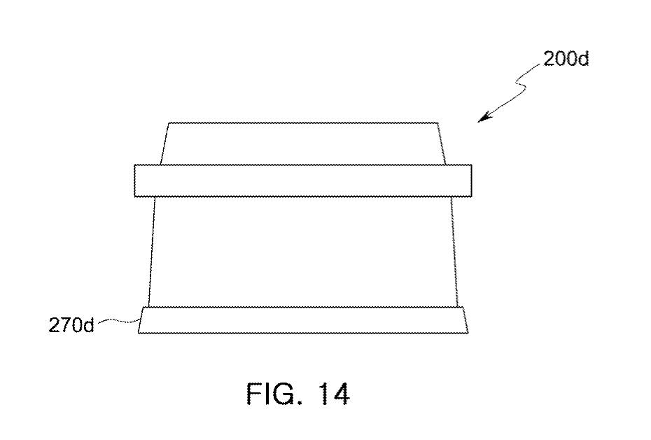

FIG. 12 is a side view of a second modified example of the lens barrel shown in FIG. 10A, FIG. 13 is a side view of a third modified example of the lens barrel shown in FIG. 10A; and FIG. 14 is a side view of a fourth modified example of the lens barrel shown in FIG. 10A.

First, the second modified example of the lens barrel 200b will be described with reference to FIG. 12. First and second protruding portions 210b and 230b protruding toward the inner surface of the housing 300 and spaced apart from each other in the optical axis (O) direction may be provided at an outer surface of the lens barrel 200b.

The first protruding portion 210b may be a portion corresponding to the second foreign object collecting portion 350 of the housing 300 and be provided upwardly of the second protruding portion 230b in the optical axis (O) direction.

Here, an outer diameter D1 of the first protruding portion 210b may be different from an outer diameter D2 of the second protruding portion 230b.

In addition, since the first and second protruding portions 210b and 230b protrude from the outer surface of the lens barrel 200b, an outer diameter D3 of the lens barrel 200b between the first and second protruding portions 210b and 230b becomes smaller than the outer diameter D1 of the first protruding portion 210b and the outer diameter D2 of second protruding portion 230b.

In this case, the outer diameter D3 of the lens barrel 200b between the first and second protruding portions 210b and 230b may be constant.

As a result, the outer diameter of the lens barrel 200b is changed at least three times.

Since the first and second protruding portions 210b and 230b protrude from the outer surface of the lens barrel 200b in the present exemplary embodiment, the outer diameter of the lens barrel 200b is discontinuously changed at least three times.

As described above, in the present exemplary embodiment, the movement direction of foreign objects moving through a gap between the lens barrel 200b and the housing 300 may be changed by changing the outer diameter of the lens barrel 200b, and foreign objects may be collected in portions at which the movement direction of foreign objects is changed, thereby preventing the foreign objects from being introduced into the image sensor.

Next, the third and fourth modified examples of the lens barrel will be described with reference to FIGS. 13 and 14.

A lens barrel 200c may sequentially include a first outer diameter portion 210c, a second outer diameter portion 230c, a third outer diameter portion 250c, and a fourth outer diameter portion 270c in order from top to bottom in the optical axis (O) direction.

Here, an outer diameter of the lens barrel 200c may be continuously changed in the first and third outer diameter portions 210c and 250c.

Further, the outer diameter of the lens barrel 200c may be constant at the second outer diameter portion 230c, and the outer diameter of the lens barrel 200c may also be constant at the fourth outer diameter portion 270c (see FIG. 13). Meanwhile, an outer diameter of a lens barrel 200d may be continuously changed in a fourth outer diameter portion 270d as shown in FIG. 14.

The second outer diameter portion 230c may have an outer diameter greater than the maximum outer diameter of the first outer diameter portion 210c, and the third outer diameter portion 250c may have an outer diameter smaller than that of the second outer diameter portion 230c. Further, the fourth outer diameter portion 270c may have an outer diameter larger than that of the third outer diameter portion 250c. Here, the fourth outer diameter portion 270c may have an outer diameter smaller than that of the second outer diameter portion 230c.

Since the outer diameter of the lens barrel 200c is continuously changed in the first outer diameter portion 210c, foreign objects may move along the first outer diameter portion 210c to thereby be collected in an upper portion of the second outer diameter portion 230c.

Since the outer diameter of the lens barrel 200c is also continuously changed in the third outer diameter portion 250c, remaining foreign objects, not collected in the upper part of the second outer diameter portion 230c move along the third outer diameter portion 250c to thereby be collected in an upper portion of the fourth outer diameter portion 270c.

As set forth above, according to exemplary embodiments of the present disclosure, even if foreign objects have been introduced into a camera module, it may be possible to prevent introduced foreign objects from reaching an image sensor.

While exemplary embodiments have been shown and described above, it will be apparent to those skilled in the art that modifications and variations could be made without departing from the spirit and scope of the present disclosure as defined by the appended claims.

What is claimed is:

1. A camera module comprising:
a lens barrel having a lens; and
a housing having the lens barrel inserted thereinto,
wherein an outer surface of the lens barrel facing an inner surface of the housing is provided with a first groove formed inwardly concave, and
the inner surface of the housing is provided with a first foreign object collecting portion formed with a step difference and a second foreign object collecting portion formed with a step difference from the first foreign object collecting portion.

2. The camera module of claim 1, wherein the outer surface of the lens barrel is provided with a protruding portion so as to correspond to the second foreign object collecting portion.

3. The camera module of claim 1, wherein the outer surface of the lens barrel is provided with a second groove formed from the first groove to be inwardly concave.

4. The camera module of claim 1, wherein a portion of the inner surface of the housing facing the outer surface of the lens barrel is a flat plane.

5. A camera module comprising:
a lens barrel having a lens; and
a housing having the lens barrel inserted thereinto,
wherein an outer surface of the lens barrel is provided with first and second protruding portions protruding toward an inner surface of the housing and spaced apart from each other in an optical axis direction.

6. The camera module of claim 5, wherein the first and second protruding portions have different outer diameters from each other.

7. The camera module of claim 5, wherein the outer surface of the lens barrel is inclined between the first and second protruding portions.

8. The camera module of claim 5, wherein the housing includes a hollow portion stepped in an optical axis direction.

9. The camera module of claim 5, wherein the inner surface of the housing is provided with a first foreign object collecting portion formed with a step difference and a second foreign object collecting portion formed with a step difference from the first foreign object collecting portion.

10. The camera module of claim 5, wherein a portion of the inner surface of the housing facing the outer surface of the lens barrel is a flat plane.

11. A camera module comprising:
a lens barrel having a lens; and
a housing having the lens barrel inserted thereinto,
wherein an outer diameter of the lens barrel is changed at least three times.

12. The camera module of claim 11, wherein the outer diameter of the lens barrel is discontinuously changed.

13. The camera module of claim 11, wherein an outer diameter of a portion of the lens barrel is continuously changed.

14. The camera module of claim 11, wherein the lens barrel includes:
a first outer diameter portion having an outer diameter being continuously changed;
a second outer diameter portion having an outer diameter greater than the maximum diameter of the first outer diameter portion;
a third outer diameter portion having an outer diameter smaller than that of the second outer diameter portion; and
a fourth outer diameter portion having an outer diameter greater than that of the third outer diameter portion.

15. The camera module of claim 14, wherein the outer diameter of the third outer diameter portion is continuously changed.

16. The camera module of claim 14, wherein the fourth outer diameter portion has the outer diameter smaller than that of the second outer diameter portion.
